(19) United States
(12) Patent Application Publication
(10) Pub. No.: US 2025/0316250 A1
(43) Pub. Date: Oct. 9, 2025

(54) Method for Dynamic Retriggering of Time-Based Audio Effects in Music Production

(71) Applicant: Nathan Harrison Rightnour, Los Angeles, CA (US)

(72) Inventor: Nathan Harrison Rightnour, Los Angeles, CA (US)

(21) Appl. No.: 18/628,852

(22) Filed: Apr. 8, 2024

(51) Int. Cl. G10H 1/00

(52) U.S. Cl. CPC G10H 1/0008; G10H 2210/031; G10H 2240/056

(57) ABSTRACT

The present invention presents a computer-implemented method for dynamically clearing a signal processor's audio buffer in a music production environment. The method involves receiving an incoming signal, which may be either a Musical Instrument Digital Interface (MIDI) signal or an audio signal, by a processing unit. The processing unit analyzes the properties of the incoming signal to determine the appropriate timing for clearing the audio buffer. Based on this determination, the audio buffer of the signal processor is reset. Additionally, the method includes automatically adjusting a volume fade associated with the resetting of the time-based audio effect process to eliminate audio artifacts. This dynamic approach allows for the retriggering of time-based audio effects without retaining undesired effects from previous signals, facilitating clearer and more distinct audio output in music production.

### FIELD OF INVENTION

The present invention relates generally to the field of digital audio processing, specifically to a method and system for dynamically managing time-based audio effects, such as reverb and delay, in music production and live performance environments through the use of computer-implemented processes.

### BACKGROUND

In the realm of music production, the pursuit of pristine sound quality is paramount, with artists and producers continually seeking innovative ways to enhance the clarity and distinctness of their musical compositions. A pervasive challenge in this quest is the management of time-based audio effects such as reverb and delay. These effects, while instrumental in adding depth and space to sound, often introduce a significant drawback: the tendency for the tails of these effects to linger over subsequent notes or pitches. This phenomenon, commonly referred to as “washout” or “bleed,” can significantly detract from the overall quality of a mix, rendering it muddy and causing the elements within it, be they instruments or vocals, to become indistinct.

The crux of the issue lies in the inability of current audio processing tools to dynamically adjust the duration of these effects in real-time in response to the incoming audio or MIDI signals. This limitation forces producers to compromise, often opting for shorter reverb times to prevent overlap, which in turn restricts the potential “size” or impact of the effect. Historically, attempts to address this issue, such as the use of gated reverb, have fallen short. While gated reverb enjoyed popularity for its distinctive sound, particularly in the 1980s, it lacks the ability to dynamically adjust to the rhythm and timing of incoming notes, resulting in either premature cut-offs or undesired bleed-over, thereby compromising the sonic integrity of the music.

Moreover, the advent of gated reverb and similar technologies has not fully addressed the underlying challenge: the seamless integration of time-based effects without sacrificing the natural flow and rhythm of the music. This limitation not only constrains the artistic expression of musicians and producers but also necessitates labor-intensive manual adjustments and fine-tuning, a process that is both time-consuming and technically demanding.

The absence of a solution that can dynamically clear the audio buffer of time-based effects in real-time based on the properties of incoming MIDI or audio signals represents a significant gap in music production technology. This gap not only hinders the creative process but also impacts the efficiency and efficacy with which artists and producers can realize their artistic vision. The need for a method that can intelligently and dynamically manage the duration and impact of time-based audio effects, thereby preserving the clarity and distinctiveness of the musical mix while allowing for creative freedom, is clear.

It is within this context that the present invention is provided.

### SUMMARY

The present invention solves the aforementioned problems by presenting a computer-implemented method for dynamically clearing a signal processor's audio buffer within a music production environment. This method entails the reception of an incoming signal by a processing unit, the signal being either a Musical Instrument Digital Interface (MIDI) signal or an audio signal. The processing unit analyzes the properties of this incoming signal to ascertain the appropriate timing for clearing the audio buffer. Following this determination, the audio buffer of the signal processor is reset at the calculated timing, and the process includes an automatic adjustment of volume (“fade out” and “fade in”) to mitigate any resultant audio artifacts. This dynamic clearing of the audio buffer in response to incoming signals facilitates the retriggering of time-based audio effects without the retention of undesired effects from previous signals.

In some embodiments, when the incoming signal is identified specifically as a MIDI signal, the properties analyzed include note-on and note-off messages, which aid in determining the timing for the clearing of the audio buffer. This specificity allows for precise control over the audio buffer's resetting process in scenarios where the user desires more control over the timing than what transients in the audio signal can provide.

In other embodiments, if the incoming signal is an audio signal, the volume of this signal is utilized to ascertain the timing for buffer clearing. This approach enables the method to dynamically adapt to varying audio signal intensities, ensuring the audio buffer is cleared at optimal moments based on signal volume.

Further embodiments include the option to trigger the resetting of the audio buffer based on a predefined threshold of the incoming signal's properties. This threshold is adjustable by the user, offering greater flexibility and customization in the management of time-based audio effects.

Another aspect of the invention involves hosting the signal processor in a dedicated low-priority CPU thread. This strategy is designed to reduce processing load and prevent audio artifacts that may arise from CPU spikes, thereby ensuring smoother audio processing.

Some embodiments alternate between multiple instances of the signal processor. This alternation allows for initialization time of the signal processor, ensuring timely and accurate retriggering of the time-based audio effect process without delay.

The method also encompasses the application of a fade-in and fade-out during the automatic volume adjustment phase. This technique smoothly transitions the effect on and off, effectively preventing clicks or pops that could detract from audio quality.

In certain embodiments, a user interface is provided for manually triggering the resetting of the audio buffer, in addition to automatic retriggering based on the properties of the incoming signal. This interface enhances user interaction and control over the audio processing method.

Employing a sidechain input to trigger the resetting of the audio buffer based on the audio properties of a different source signal allows for creative control over which signals influence the retriggering of the time-based audio effect, broadening the method's applicability.

In embodiments where the time-based audio effect process encompasses reverb, delay, or echo, the method enables dynamic management of the effect's duration and intensity in response to the incoming signal, thus allowing for a more nuanced audio production.

Utilizing a Hold feature that maintains the time-based effect for a predetermined duration after retriggering, before clearing the audio buffer, grants users enhanced control over the sustain duration of the effect, further customizing the audio output.

Incorporating a hysteresis mechanism in the analysis of incoming signal properties allows for the adjustment of sensitivity to changes in these properties, ensuring the timing for clearing the audio buffer is optimally determined.

The inclusion of a filter in the analysis of the incoming audio signal, selectable between fullpass, low-pass, and high-pass modes with adjustable cutoff frequency, enables selective triggering of the resetting based on specific frequency content of the incoming audio signal.

Implementing the method as a digital audio workstation (DAW) plugin facilitates the hosting of third-party signal processor plugins for applying and dynamically managing time-based audio effects based on the properties of incoming MIDI or audio signals.

In embodiments where the DAW plugin provides real-time visual feedback of the time-based audio effect process, users gain immediate insights into the retriggering events and the current state of the audio buffer, enhancing usability and interaction.

Lastly, ensuring the DAW plugin's compatibility with multiple plugin formats, including but not limited to VST3, Audio Units (AU), and AAX, extends the method's applicability across various music production software platforms, broadening its utility within the music production domain.

### BRIEF DESCRIPTION OF THE DRAWINGS

Various embodiments of the invention are disclosed in the following detailed description and accompanying drawings.

FIG. 1 illustrates an example flowchart depicting the method steps for dynamically managing the clearing of a signal processor's audio buffer in response to incoming signals.

FIG. 2 illustrates an example user interface of the Silencer plugin, showing the initial selection screen for various reverb effects before loading a time-based effect.

FIG. 3 illustrates an example advanced triggering options panel of the Silencer plugin, featuring controls for hysteresis and selectable audio filters for reverb triggering.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

For the purposes of this disclosure, ‘signal processor’ refers to any hardware or software module capable of modifying or processing audio signals. This includes, but is not limited to, digital audio workstations (DAWs), standalone audio effects plugins, and physical audio processing units. Examples of signal processors include software plugins running on computer-based DAWs like Ableton Live, Pro Tools, Logic Pro, or hardware units such as digital reverb processors.

‘Incoming signal’ encompasses any audio or MIDI data received by the signal processor. This may include live audio feeds, prerecorded audio tracks, live MIDI signals from musical instruments, or MIDI sequences. The term ‘properties’ of the incoming signal refers to characteristics such as frequency, amplitude, duration, and MIDI note values, among others.

This invention is applicable in a variety of music production environments, ranging from studio recording sessions to live performances. It is designed to integrate seamlessly with existing music production software and hardware, enhancing the quality and clarity of audio output by dynamically managing time-based audio effects.

The method described herein may be implemented as part of a digital audio workstation (DAW) plugin or as a standalone application. It is designed to be compatible with various audio plugin formats such as VST3, AU (Audio Units), AAX, and RTAS, ensuring wide usability across different music production platforms. The system architecture may leverage existing APIs (Application Programming Interfaces) for audio processing, such as the Steinberg VST3 SDK for plugin development or the JUCE framework for cross-platform audio software development.

The process of analyzing the properties of the incoming signal and determining the timing for clearing the audio buffer can be facilitated by digital signal processing (DSP) algorithms. These algorithms may analyze the incoming signal in real-time, employing techniques such as Fast Fourier Transform (FFT) for frequency analysis or amplitude envelope detection for volume analysis.

The implementation of this method requires a computing device with sufficient processing power to handle real-time audio processing tasks. This includes, but is not limited to, personal computers, laptops, digital audio workstations, and dedicated audio processing units. The software aspect of the invention is designed to operate on major operating systems including Windows, macOS, and Linux, ensuring broad accessibility for users across different platforms.

### DESCRIPTION OF DRAWINGS

The present invention relates to a method and system for dynamically managing audio processing, specifically focusing on the clearing of signal processors' audio buffers in response to incoming signals in a music production environment. The invention provides a computer-implemented approach to dynamically adjust and reset the audio buffer of a signal processor, such as an audio effect plugin, thereby enabling the retriggering of time-based audio effects like reverb and delay without the undesired retention of effects from previous audio or MIDI signals.

The process that involves receiving incoming audio or MIDI signals, analyzing these signals to determine specific properties (e.g., frequency, amplitude, duration, MIDI note values), and based on this analysis, determining the optimal timing for clearing the audio buffer. The method then resets the audio buffer at this determined timing and automatically adjusts volume fade parameters to mitigate any potential audio artifacts that might arise during the reset process. This ensures that the subsequent audio output is free from unwanted residual effects, thereby preserving the clarity and quality of the music production.

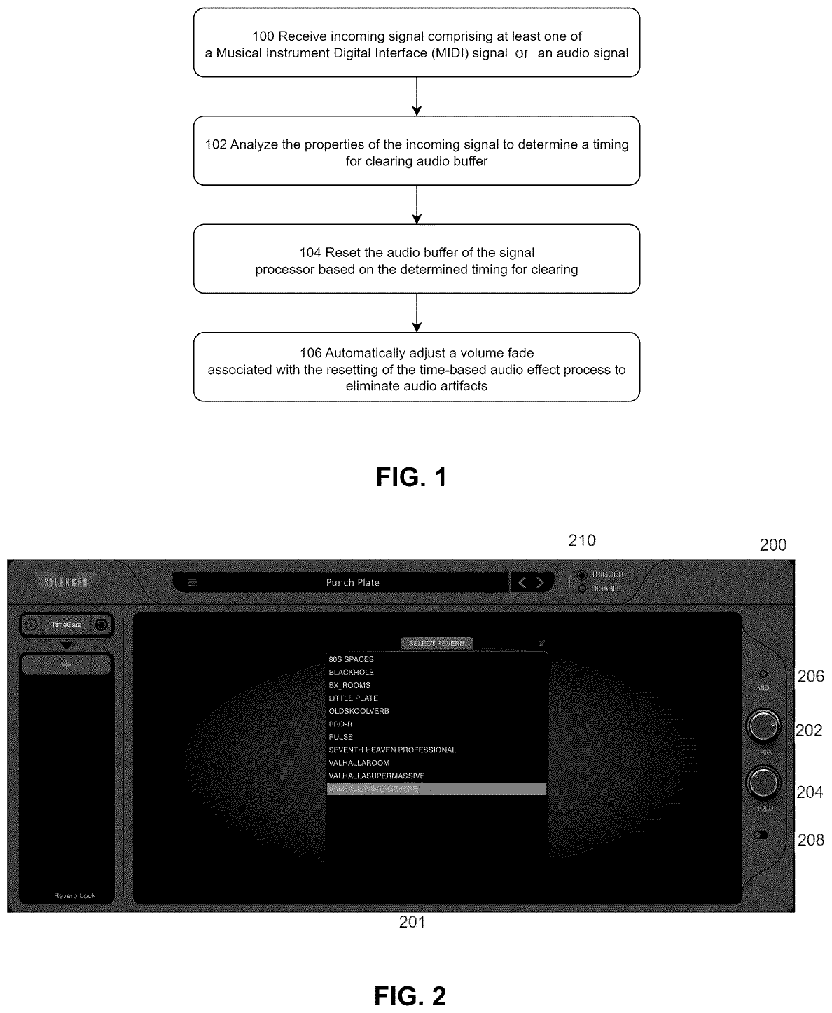

FIG. 1 presents a flowchart outlining the operational steps of a method for dynamically managing the clearing of a signal processor's audio buffer within a music production environment. The process begins with the reception of an incoming signal 100. This initial step involves the processing unit's reception of either a Musical Instrument Digital Interface (MIDI) signal or an audio signal, capturing inputs such as live audio feeds, prerecorded audio tracks, MIDI signals from musical instruments, or MIDI sequences.

Following the receipt of the incoming signal, the method proceeds to the analysis of the signal's properties 102. During this phase, the processing unit evaluates characteristics such as frequency, amplitude, duration, and MIDI note values for the incoming signal. The purpose of this analysis is to identify the precise timing at which the audio buffer should be cleared to optimize the audio output's clarity and fidelity. The processing unit may employ digital signal processing (DSP) algorithms for accurate, real-time analysis of the signal.

Once the optimal timing for clearing the audio buffer is determined, the method advances to the resetting of the audio buffer 104. Executed based on the timing identified in the analysis phase, this step ensures that the signal processor's audio buffer is cleared at the precise moment necessary to prevent the carryover of undesired effects from previous signals. This step may be facilitated through calling a background reset function or other means such as direct control mechanisms or through application programming interfaces (APIs) that interface with the signal processor.

The final step depicted in the flowchart is the automatic adjustment of a volume fade 106 associated with the resetting process. This adjustment is for eliminating potential audio artifacts, such as clicks or pops, that might occur during the buffer clearing process. By automatically fine-tuning the volume fade, the processing unit ensures a seamless transition in audio output, maintaining the audio's quality and integrity. This involves utilizing software protocols or hardware capabilities designed for dynamic control over audio signal levels.

The sequence of steps is designed to ensure the dynamic clearing of the audio buffer in response to incoming signals, enabling the retriggering of time-based audio effects without retaining undesired effects from previous signals.

FIG. 2 presents an example user interface 200 of a software plugin called Silencer, which operates the invention for retriggering time-based audio effects within a digital audio workstation (DAW). Displayed before any time-based effect has been loaded, the interface provides the user with a list of reverbs 201 to select from for the purpose of retriggering. The selectable reverbs include a variety of options such as 80s Spaces, Blackhole, and Little Plate, among others, allowing the user to choose the desired reverb effect to apply and dynamically manage using the Silencer plugin. The list provided is merely an example of a set of time-based plugins installed on a given user's computer; it will look different for each user.

Within the interface 200, controls for managing the retriggering process are evident. A TRIG knob 202 and a HOLD knob 204 are provided to adjust the sensitivity to the incoming signal and to set the time interval at which retriggering is permissible, respectively. The TRIG knob 202 is used to lower the threshold for retriggering, while the HOLD knob 204 determines how frequently the retriggering can occur, providing the user with control over the rhythmic alignment of the effect with the audio material, such as a drum loop.

Additionally, the interface includes a MIDI trigger option 206 that enables retriggering based on MIDI input from the DAW, offering an alternative to audio signal-based triggering. This feature is particularly useful for instruments or audio sources that lack strong transients, like vocals, where MIDI data can provide a more precise triggering mechanism.

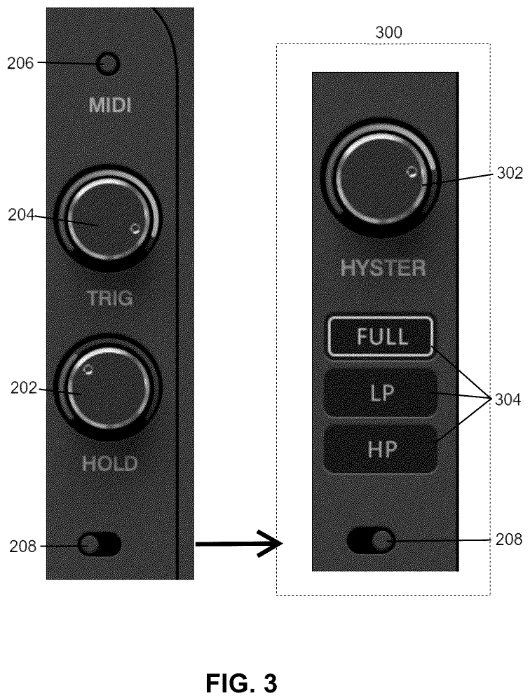

Below the MIDI trigger is a toggle 208 for allowing a user to access more advanced options, which are delineated in FIG. 3.

The user interface 200 is designed to facilitate a range of control over the retriggering process, providing the user with options to define the duration of the time-based effect sustain after a trigger event, employ fade-out times before retriggering, or even use a sidechain input as a trigger for greater creative flexibility. The process can be customized further to react to user-defined musical rhythms, allowing the effect to retrigger at specific intervals such as every eighth note or quarter note, or at set time intervals measured in milliseconds.

The capability to interface with various plugin formats and musical hardware makes the invention a versatile tool not only for studio production but also for live performance settings. In live applications, the invention can be employed to eliminate unwanted feedback by automatically disabling an audio process if the source signal possesses audio properties that could lead to feedback or other undesirable audio artifacts.

FIG. 3 displays a segment of the user interface 300 for advanced triggering options within the Silencer plugin. The segment includes a control for hysteresis 302, which is a parameter that sets the volume change required until the next trigger is allowed. This parameter ensures that retriggering only occurs when there is a significant enough change in the incoming signal's volume, thus preventing over-triggering in response to minor fluctuations.

Below the hysteresis control 302, there is a selection of filter types 304 that can be applied to the incoming audio signal for the purpose of triggering the retriggering process. The filter options include a fullpass filter, which allows all frequencies of the audio signal to trigger the retriggering; a low-pass filter (LP), which only allows frequencies below a certain cutoff point to initiate retriggering; and a high-pass filter (HP), which only allows frequencies above a certain cutoff point to initiate retriggering. These filter options provide the user with the ability to refine which parts of the audio signal can trigger the retriggering of the time-based effect, offering a more tailored approach to managing the effect's application.

The user can select the desired filter type by engaging the corresponding button-FULL for fullpass, LP for low-pass, and HP for high-pass-and can set the specific cutoff frequency by dragging a control within the user interface (not shown). It is important to note that the choice of filter type and the setting of the cutoff frequency only affect the conditions under which the reverb is triggered and do not alter the actual sound of the dry or wet signal being processed.

In some implementations, the disclosed method additionally incorporates a feature that allows the user to manually initiate the retriggering mechanism through the use of the TRIGGER button. This manual retriggering capability enables the user to interact directly with the music production process, offering an immediate method to apply the retriggering effect as desired. The actions performed using the TRIGGER button can be captured in real-time by the digital audio workstation (DAW) as automation data. This data records the timing and pattern of the manual retriggering events, thereby allowing the DAW to replicate the exact performance upon playback, ensuring that the manual interventions are preserved and can be replicated or modified as needed.

Moreover, this implementation of the method offers flexibility in the use of automation for retriggering. Instead of recording a live performance, the user has the option to constructively draw or program the automation data within the DAW. This programmed automation serves as a third method for retriggering the mechanism, separate from and potentially in addition to the audio or MIDI signal-based methods. Through the DAW's automation capabilities, users can meticulously define the precise timings at which the retriggering should occur, effectively allowing the DAW itself to manage the retriggering process according to the user-defined parameters.

The disclosed system and methods may be implemented using any suitable computer processor architecture.

A computer may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

### Conclusion

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the method of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A computer-implemented method for dynamically clearing a signal processor's audio buffer in a music production environment, the method comprising:
receiving, by a processing unit, an incoming signal, wherein the incoming signal comprises at least one of a Musical Instrument Digital Interface (MIDI) signal or an audio signal;
analyzing, by the processing unit, properties of the incoming signal to determine a timing for clearing the audio buffer;
resetting, by the processing unit, the audio buffer of the signal processor based on the determined timing for clearing; and
automatically adjusting, by the processing unit, a volume fade associated with the resetting of the time-based audio effect process to eliminate audio artifacts,
wherein the audio buffer is cleared dynamically in response to the incoming signal to allow for the retriggering of the time-based audio effect without sustaining undesired effects from previous signals.

2. The method of claim 1, wherein the incoming signal is a Musical Instrument Digital Interface (MIDI) signal, and the properties of the incoming signal include note-on and note-off messages used to determine the timing for clearing the audio buffer.

3. The method of claim 1, wherein the incoming signal is an audio signal, and the properties of the incoming signal include the volume of the audio signal used to determine the timing for clearing the audio buffer.

4. The method of claim 1, further comprising triggering the resetting of the audio buffer based on a predefined threshold of the incoming signal's properties, wherein the threshold is adjustable by a user.

5. The method of claim 1, further comprising hosting the signal processor in a dedicated low-priority CPU thread to reduce processing load and prevent audio artifacts associated with CPU spikes.

6. The method of claim 1, further comprising alternating between multiple instances of the signal processor to allow for initialization time of the signal processor, thereby ensuring timely and accurate retriggering of the time-based audio effect process.

7. The method of claim 1, wherein the step of automatically adjusting a volume fade includes applying a fade-in and fade-out to the time-based audio effect process to smoothly transition the effect on and off, thereby preventing clicks or pops.

8. The method of claim 1, further comprising providing a user interface that allows for manual triggering of the resetting of the audio buffer, in addition to automatic retriggering based on the properties of the incoming signal.

9. The method of claim 1, further comprising employing a sidechain input to trigger the resetting of the audio buffer based on the audio properties of a different source signal, allowing for creative control over which signals influence the retriggering of the time-based audio effect.

10. The method of claim 1, wherein the time-based audio effect process includes at least one of reverb, delay, or echo, and the method facilitates dynamic management of the effect's duration and intensity in response to the incoming signal.

11. The method of claim 1, further comprising utilizing a Hold feature that allows for the time-based effect to sustain for a predetermined duration after retriggering, before the audio buffer is cleared, providing users with control over the sustain duration of the effect.

12. The method of claim 1, wherein the step of analyzing properties of the incoming signal further includes employing a hysteresis mechanism to determine the timing for clearing the audio buffer, thereby allowing for the adjustment of sensitivity to changes in the incoming signal's properties.

13. The method of claim 1, further including the use of a filter in the analysis of the incoming audio signal, wherein the filter is selectable between fullpass, low-pass, and high-pass modes, and the cutoff frequency of the filter is adjustable, enabling the selective triggering of the resetting based on specific frequency content of the incoming audio signal.

14. The method of claim 1, implemented as a digital audio workstation (DAW) plugin, wherein the plugin is capable of hosting third-party signal processor plugins for applying and dynamically managing time-based audio effects based on the properties of incoming MIDI or audio signals.

15. The method of claim 14, wherein the DAW plugin includes a user interface providing real-time visual feedback of the time-based audio effect process, including visual indicators of the retriggering events and the current state of the audio buffer.

16. The method of claim 14, wherein the DAW plugin is compatible with multiple plugin formats, including but not limited to VST3, Audio Units (AU), AAX, and RTAS, facilitating its use across various music production software platforms.

17. The method of claim 1, further comprising manually initiating the retriggering of the time-based audio effect process by a user through the actuation of a TRIGGER button provided in a user interface 210, wherein the manual retriggering can be recorded as automation data within the DAW to replicate the retriggering events during playback.

18. The method of claim 17, wherein the automation data corresponding to the manual retriggering is programmable by the user in the digital audio workstation (DAW) plugin, allowing for the definition of specific timings for the retriggering of the time-based audio effect process independent of the incoming audio or MIDI signal.

19. The method of claim 17, further comprising the use of the recorded automation data to control the retriggering mechanism in synchronization with either the incoming audio signal or the MIDI signal, or as a standalone retriggering method.
